(19) United States
(12) Patent Application Publication
(10) Pub. No.: US 2005/0231055 A1
(43) Pub. Date: Oct. 20, 2005

(54) Inductively coupled drive module for electrically powered models

(75) Inventor: Graham John Chamot Rooke, Blackburn (AU)

Correspondence Address: MCKEE, VOORHEES & SEASE, P.L.C., 801 GRAND AVENUE, SUITE 3200, DES MOINES, IA, 50309-2721, US

(73) Assignees: Margaret Wyn Rooke, Blackburn (AU); Stuart Alexander Lionel Rooke, Ringwood (AU)

(21) Appl. No.: 10/514,702

(22) PCT Filed: May 16, 2003
(86) PCT No.: PCT/AU03/00589

§ 371 Date: Nov. 16, 2004

(30) Foreign Application Priority Data
May 16, 2002 (AU) PS 2375

(51) Int. Cl. H02P 15/00; H02K 49/00

(52) U.S. Cl. 310/103

(57) ABSTRACT

An inductively coupled drive module for small scale model vehicles, the module including an electric motor having at least one output shaft having an axis of rotation; and at least one inductive coupling, the inductive coupling having: a body which includes a drive shaft which is coaxial with said output shaft, an opening to permit a first end portion of said output shaft to extend within the body, bearings located within the body to permit the body to rotate about said axis but independently of rotation of said output shaft, and a member mounted on said output shaft for rotation therewith and within a cavity formed in the body, the member being: (a) made from or includes magnetic material, or (b) made from or includes electrically conductive material; and wherein the body is: (c) made from or includes electrically conductive material, (when the member is made from or includes magnetic material), or (d) made from or includes magnetic material (when the member is made from or includes electrically conductive material), the arrangement being such that when the electric motor rotates and its output shaft rotates, the member rotates within the body so that induced currents will flow in the body or member which currents will react the magnetic material in the member or mounting body and cause a torque to be applied to the body to thereby cause rotation thereof and consequential rotation of the drive shaft.

More particularly the invention relates to an Inductively Coupled Drive Module [ICDM] designed for application to electrically powered model railway locomotives. It will be appreciated that the ICDM could be also used in other models such as land vehicles (cars, trucks, military vehicles or the like) which incorporate electric motors for providing the movement of the models.

The ICDM is specifically designed for application to “Small Scale” models. “Small Scale” covers the range of model scales between 160:1 (1 prototype ft=2 mm) and 32:1 (1 prototype ft=10 mm). The most popular model railway scale worldwide, generically known as HO scale, has a scale ratio of 87:1 [1 prototype ft=3.5 mm]. The detailed description of the ICDM relates to this scale, however ICDM's constructed in accordance with this invention cater for all small scale models.

Installation of an ICDM in a model provides truly prototypical model operation that is unable to be achieved with any presently available electric drive mechanism.

All electric-motor driven models are presently fitted with “direct connected” drive systems, which means that the electric driving motor is permanently connected through some form of fixed-ratio reduction gear set to the model's driving wheels. Substantially all “small scale” model railway locomotives are powered by 12 volt DC motors, where 0 V dc gives zero speed and 12 V dc gives maximum torque and full speed.

The gear sets are assembled to provide the required gear reduction either from a selection of spur gears, or a combination of spur gears and a worm drive.

The resultant combination of motor power, model speed and tractive effort is therefore always a compromise design, which provides a preset and fixed set of operating conditions that prevent the model from operating in a way which properly replicates the operation of the prototype.

Operation of a model railway locomotive in prototypical mode requires that the model replicates, as closely as possible, the operational characteristics of a prototype locomotive powered by a diesel or petrol engine. Prototype operation is similar in many respects to the operation of a motor car with automatic transmission, in that the engine power is continually adjusted by the driver modifying the engine speed (by accelerator adjustment) to meet the varying requirements of tractive effort and speed. For example, starting to move a car uphill when towing a load such as a boat on a trailer requires much higher tractive effort than starting to move the same car with no load downhill.

All prototype diesel or petrol engine railroad locomotives incorporate some form of variable power transfer mechanisms between the driving engine and the wheel sets to enable them to start smoothly and operate at varying speeds with varying loads. Prototype engines are usually started in a no load mode to ensure that engines are protected from initial overload and that correct operating conditions are established before working loads are applied.

Electric motor driven model railway locomotives are not currently able to accurately replicate prototypical variable torque power characteristics. In known electric motor driven model railway locomotives, the preset, fixed mechanical coupling between the driving motor and the driven wheel or wheels of the locomotive results in the electric motor speed to locomotive speed ratio being fixed, thus precluding variable torque and preventing accurate replication of prototypical operation.

In accordance with the invention, the problems of non-prototypical operation of a model associated with the prior art can eliminated by replacing the fixed mechanical coupling between the drive motor and the driving wheels with an ICDM.

According to the present invention there is provided an inductively coupled drive module for small scale model vehicles, the module including an electric motor having at least one output shaft having an axis of rotation; and at least one inductive coupling, the inductive coupling having:
a body which includes a drive shaft which is coaxial with said output shaft,
an opening to permit a first end portion of said output shaft to extend within the body,
bearings located within the body to permit the body to rotate about said axis but independently of rotation of said output shaft, and
a member mounted on said output shaft for rotation therewith and within a cavity formed in the body, the member being:
   (a) made from or includes magnetic material, or
   (b) made from or includes electrically conductive material; and
wherein the body is:
   (c) made from or includes electrically conductive material, (when the member is made from or includes magnetic material), or
   (d) made from or includes magnetic material (when the member is made from or includes electrically conductive material),
      the arrangement being such that when the electric motor rotates and its output shaft rotates, the member rotates within the body so that induced currents will flow in the body or member which currents will react with the magnetic material in the member or mounting body and cause a torque to be applied to the body to thereby cause rotation thereof and consequential rotation of the drive shaft.

Preferably the module includes first and second of said inductive coupling.

The invention also provides small scale model locomotive including
a chassis,
wheels mounted on the chassis,
an inductively coupled drive module as defined above mounted on the chassis, and
means for coupling said drive shaft of said inductive coupling to at least one of said wheels.

The invention also provides a method of operating a model vehicle having a chassis, wheels and electric motor and a transmission for coupling an output shaft of the motor, the method including the steps of:
providing an inductive coupling in said transmission, the coupling including an electrically inductive component and a magnetic component, and
selecting the size, location, conductivity and/or magnetic strength of said components so that there is a predetermined coupling efficiency between said parts and the motion of the model substantially replicates the motion of the prototype thereof.

Preferably, the coupling efficiency of the ICDM can be adjusted to enable its effective use in a variety prototype models in different scales and model weights.

Preferably, further the module includes an arrangement for selecting the inductive coupling transfer characteristics for model frame sizes, where the frame sizes are determined by the physical size constraints of the model scale ratios.

The output from each inductive coupling is normally connected to the driving wheels of the model through standard spur and/or worm/worm gear sets. With the ICDM installed in a model locomotive there is no longer a direct mechanical connection between the drive motor and the driving wheels and prototypical operation of the model is now possible depending upon the design parameters of the ICDM motor and integrated inductive couplings.

The invention will now be further described with reference to the accompanying drawings, in which:

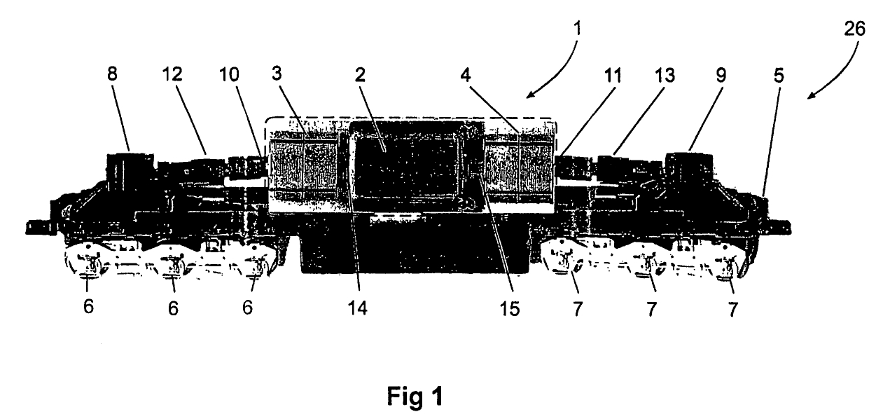

FIG. 1 is a schematic view of a model locomotive chassis incorporating an ICDM constructed in accordance with this invention;

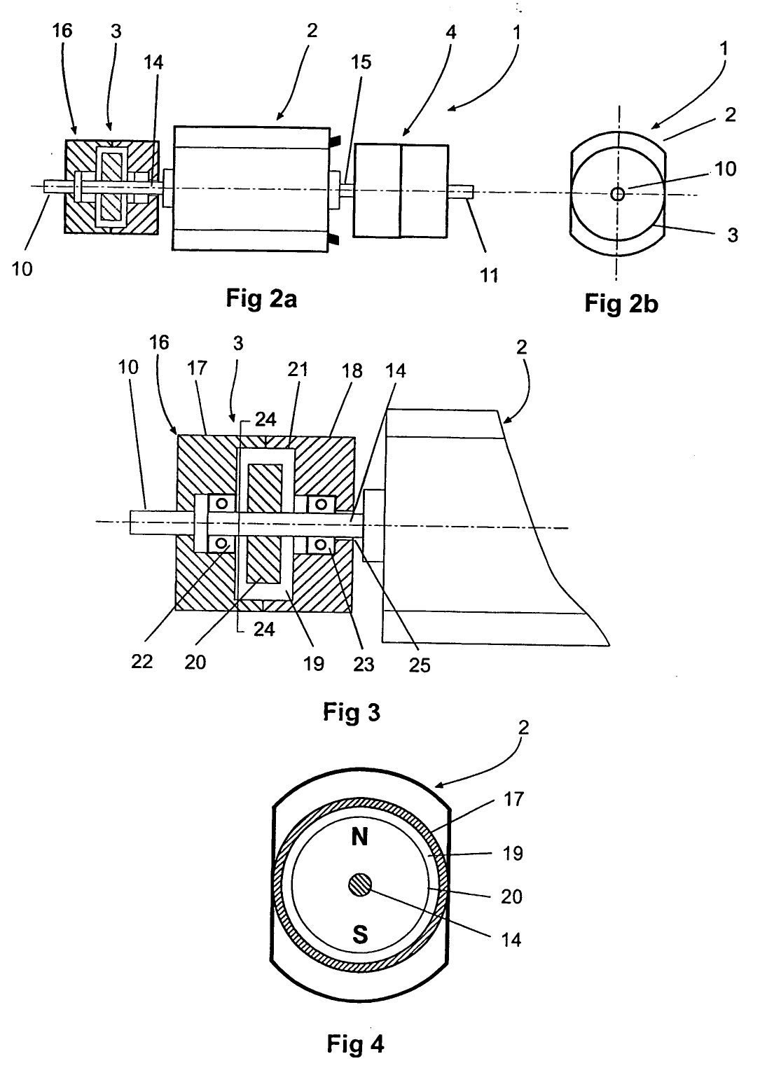

FIG. 2a is a side view partly in section of an ICDM constructed in accordance with the invention;

FIG. 2b is an end view of the IDCM;

FIG. 3 is a cross-sectional view through one of the two inductive couplings of the invention; and

FIG. 4 is a cross-sectional view along line 24-24.

FIG. 1 shows a model vehicle 26 such as a model locomotive, with the bodywork removed. The locomotive includes a chassis 5, front wheels 6 and rear wheels 7. An ICDM 1 is mounted on the chassis 5 and has forward and rear output shafts 10 and 11.

The ICDM 1 is constructed in accordance with the invention and comprises a motor 2 with forward and rear inductive couplings 3 and 4 integral with motor 2 output shafts 14 and 15. The vehicle 26 includes reduction gear sets 8 and 9 having input shafts 12 and 13 respectively. The ICDM output shafts 10 and 11 are coupled to the gear set input shafts 12 and 13 respectively. The gear sets 8 and 9 normally include internal bearings. Therefore the input shafts 12 and 13 do not require separate bearings because they are coupled at one end to the gear sets 8 and 9 and at the other end to the inductive couplings 3 and 4 all of which have their own bearings. The shafts 12 and 13 would normally include splined couplings (now shown) intermediate of their length so as to allow for limited elongation thereof which is required for rotation of the front and rear wheel 6 and 7 during cornering. The ICDM 1 could be provided with a mounting plate (not shown) upon which the motor 2 is mounted in order to facilitate connection of the ICDM 1 to the chassis 5. In most cases however a modeler would normally mount the ICDM using adhesive tape or the like so that a mounting plate would not normally be required.

FIG. 2a shows a side view of the ICDM 1 with inductive couplings 3 and 4 integral with motor 2 and the inductive coupling 3 shown in cross section. FIGS. 3 and 4 show the structure of the inductive coupling 3 in more detail. The inductive couplings 3 and 4 are identical and therefore only one of them needs to be described in detail.

The coupling 3 includes cylindrical parts 17 and 18 which are joined at their circumference to form a mounting body 16 for the components. Within the body 16 is an air cavity 21 within which is located a disc magnet 20 attached to the extended shaft 14. Two miniature ball bearings 22 and 23 are mounted in the body 16 and are attached to motor shaft 14 and enable the mounting body 16 to rotate freely about motor shaft 14. The cylindrical part 17 is connected to the end of the forward shaft 10 so that the shafts 10 and 14 can rotate coaxially but independently of one another. A hole 25 in the cylindrical part 18 allows the shaft 14 to pass into the interior of the body 16. The output shaft 10 provides a connection between the coupling 3 and the driving wheels 6 via gear set input shaft 12 and reduction gear set 8. The cylindrical parts 17 and 18 are preferably made from electrically conductive material and are preferably relatively dense so that the body 16 functions as a flywheel. Brass or copper is a suitable material for the parts 17 and 18.

In use, the motor 2 output rotates by applying a variable DC voltage of up to 12 volts across its two power input terminations (not shown). The polarity of the applied motor voltage determines the rotational direction of motor 2. The voltage level determines the speed of rotation of motor 2. Rotation (in either direction) of motor 2 causes rotation of magnet 20 in unison therewith. The permanent magnet 20 is magnetized with alternate poles as shown in FIG. 4. The rotation of magnet 20 causes induced currents to flow in the mounting body 16 which is located adjacent thereto causing a reactive force which produces consequential rotation of the body 16. The output shaft 10 rotates with the body 16 and causes rotation of wheels 6 via input shaft 12 and gear set 8. It is noted that the coupling 3 operates as described for either direction of rotation of motor 2, thus the directional movement of the model 26 is determined by the polarity of the power supply to motor 2.

The operating characteristics and physical size of motor 2 together with operating characteristics and size of couplings 3 and 4 are matched to provide a desired range of ICDM outputs for each model size and weight within each model scale.

Using the most common scale of “HO” as an example only, motor 2 is a miniature flat can of 16 mm wide×20 mm high×25 mm long, with a maximum speed of 19,000 RPM and a maximum stall torque of 100 gmf·cm. Because of the miniature sizes of the inductive couplings required to enable an ICDM to be fitted to small scale models, motor rotational speeds of between 12,000 and 15,000 RPM are normally required to transfer the required driving power and torque to the wheel sets of the model. The miniature inductive couplings 3 and 4 are preferably 15 mm diameter and 15 mm long with an air cavity 21 of 13 mm diameter and 5 mm long. The overall dimensions of ICDM 1 for HO scale fit within a volume frame of 61 mm long, 16 mm wide and 20 mm high.

The output power of ICDM 1 is determined by motor 2 input voltage and the selection of magnet 20 characteristics which determine the power transfer function of couplings 3 and 4. It will be appreciated that using the same specifications for magnet 20, but varying its diameter and width within the limits of the coupling air cavity 21 will alter the effective air gap 19 between the magnet surfaces and the walls of the air cavity 21, thus providing a range of maximum ICDM output power levels for the same power input to motor 2. The couplings 3 and 4 are normally fitted with magnets of the same size and specification to ensure that power to wheel sets 6 and 7 are equal. All magnets are preferably of rare earth materials and have a strength of BH equal to about 38 MGOe.

The following details provide typical examples of the sizes of the magnet 20 to provide differing ICDM maximum power outputs when full voltages are applied to the motor 2.

### EXAMPLE 1

A small light mainline diesel HO scale model locomotive requires a maximum torque of about 20 gmf·cm to operate prototypically under all conditions. This torque level is obtained with magnet 20 dimensions of 12 mm diameter and 3.5 mm wide; at a motor 2 rotational speed of 11,200 RPM. The air gap 19 is thus 0.5 mm in the radial direction and 0.75 mm in the axial direction.

### EXAMPLE 2

A large heavy mainline diesel HO scale model locomotive requires a maximum torque of about 40 gmf·cm to operate prototypically under all conditions. This torque level is obtained with magnet 20 dimensions of 12.75 mm diameter and 4.5 mm wide; at a motor 2 rotational speed of 14,600 RPM. The air gap 19 is thus 0.125 mm in the radial direction and 0.25 mm in the axial direction.

Smaller scales and larger scales constructed in accordance with this invention utilize motors and couplings to suit the volume frame size available for each particular scale.

In operation, a model locomotive fitted with an ICDM will start moving when the ICDM output exceeds the static frictional forces. These forces are dependent on the model weight and bearing and wheel friction. Power to the locomotive wheel sets is controlled by the voltage applied to the ICDM motor and the power transfer function of the ICDM inductive couplings. This control voltage is varied by the operator using a throttle control. The operator must increase the throttle position to increase the voltage to the ICDM motor to a level where the ICDM output power exceeds the restraining forces, mainly attributable to static friction. Once motion of the model has started, the restraining forces will change according the movement of the models, and thus the throttle position should be adjusted to maintain a required motion. Prototypical operation of the model can therefore be substantially replicated.

Many modifications will be apparent to those skilled in the art without departing from the spirit and scope of this invention. These may include a single-ended ICDM employing only one coupling, which is suitable for driving models with a single wheel set; or differing motor-magnet matching combinations for specific model applications.

It will also be appreciated that the module can be made to function if the positions of the magnet and the conductive material are reversed. In other words, the disc 20 would be made from or include electrically conductive material and the mounting body 16 would be formed from or include permanent magnet material so as to have at least one pair of poles. In this arrangement if the disc 20 is rotated induced currents flowing therein will generate magnetic forces which in turn will react with the permanent magnet to cause rotation of the body 16.

Further, in the preferred embodiment described above, the electric motor has a single shaft the ends of which form the output shafts 14 and 15 which extend into the inductive couplings 3 and 4. It would be possible to construct the module with separate shaft components which are joined together to form a single shaft although the unitary shaft as described above is preferred.

1. An inductively coupled drive module for small scale model vehicles, the module including an electric motor having at least one output shaft having an axis of rotation; and
at least one inductive coupling, the inductive coupling having:
a body which includes a drive shaft which is coaxial with said output shaft,
an opening to permit a first end portion of said output shaft to extend within the body,
bearings located within the body to permit the body to rotate about said axis but independently of rotation of said output shaft, and
a member mounted on said output shaft for rotation therewith and within a cavity formed in the body, the member being:
(a) made from or includes magnetic material, or
(b) made from or includes electrically conductive material; and wherein the body is:
(c) made from or includes electrically conductive material (when the member is made from or includes magnetic material), or
(d) made from or includes magnetic material (when the member is made from or includes electrically conductive material),
the arrangement being such that when the electric motor rotates and its output shaft rotates, the member rotates within the body so that induced currents will flow in the body or member which currents will react the magnetic material in the member or mounting body and cause a torque to be applied to the body to thereby cause rotation thereof and consequential rotation of the drive shaft.

2. A drive module as claimed in claim 1 including first and second of said inductive couplings, and wherein the output shaft has a second end portion which passes through the opening in the body of the second inductive coupling.

3. The drive module as claimed in claim 2 wherein said first and second portions are integral with said output shaft.

4. A drive module as claimed in claim 2 wherein each member is made from magnetic material which is magnetized so as to have at least two poles.

5. A drive module as claimed in claim 2 wherein each member is a disc concentrically mounted on respective end portions of said output shaft.

6. A drive module as claimed in claim 5 wherein air gaps are defined between the discs and said cavities.

7. A drive module as claimed in claim 5 wherein the air gaps include radial and axial air gaps.

8. A drive module as claimed in claim 7 wherein the radial air gaps are in the range from 0.125 to 0.5 mm.

9. A drive module as claimed in claim 7 wherein the axial air gaps are in the range from 0.25 to 0.75 mm.

10. A drive module as claimed in claim 1 wherein the size of the module is such that it can be located within a cuboid having the following dimensions: length 61 mm, width 16 mm and height 20 mm.

11. A small scale model locomotive including
a chassis,
wheels mounted on the chassis,
an inductively coupled drive module as claimed in claim 1 mounted on the chasses, and
means for coupling said drive shaft of said inductive coupling to at least one of said wheels.

12. A method of operating a model vehicle having a chassis, wheels and electric motor and a transmission for coupling an output shaft of the motor, the method including the steps of:
providing an inductive coupling in said transmission, the coupling including an electrically inductive component and a magnetic component, and
selecting the size, location, conductivity and/or magnetic strength of said components so that there is a predetermined coupling efficiency between said parts and the motion of the model substantially replicates the motion of the prototype thereof.

13. An inductively coupled drive module for small scale model vehicles, the module including an electric motor having at least one output shaft having an axis of rotation; and at least one inductive coupling, the inductive coupling having:
a first shaft having a first coupling member mounted thereon for rotation therewith;
a second shaft having a second coupling member mounted thereon for rotation therewith;
mounting means for mounting the first and second shafts for rotation co-axially with said axis of rotation and the first shaft being constrained to rotate in unison with the output shaft of the motor; and
wherein one of the first and second coupling members is made from or includes magnetic material having a magnetic field and the other of the first and second coupling members is made from or includes electrically conductive material whereby rotation of the motor causes rotation of the first shaft whereby there is relative movement of said electrically conductive material and said magnetic field causing in use currents to be induced in the conductive material which produce a rotational torque on said second shaft.

14. A drive module as claimed in claim 13 including first and second of said inductive couplings.

15. The drive module as claimed in claim 14 wherein the drive shaft of the motor is integral with the first shaft of the first and second inductive couplings.

16. An inductively coupled drive module for small scale model vehicles, the module being adapted for coupling to an electric motor having a motor output shaft, the module having at least one output shaft having an axis of rotation; and at least one inductive coupling, the inductive coupling having:
a first shaft having a first coupling member mounted thereon for rotation therewith;
a second shaft having a second coupling member mounted thereon for rotation therewith;
mounting means for mounting the first and second shafts for rotation co-axially with said axis of rotation and the first shaft being constrained, in use, to rotate in unison with the motor output shaft; and
wherein one of the first and second coupling members is made from or includes magnetic material having a magnetic field and the other of the first and second coupling members is made from or includes electrically conductive material whereby rotation of the motor causes rotation of the first shaft whereby there is relative movement of said electrically conductive material and said magnetic field causing in use currents to be induced in the conductive material which produce a rotational torque on said second shaft.
